(19) United States
(12) Patent Application Publication
(10) Pub. No.: US 2026/0231076 A1
(43) Pub. Date: Aug. 6, 2026

(54) TECHNIQUES FOR SUPPORTING NETWORK SLICE GROUPS

(71) Applicant: Apple Inc., Cupertino, CA (US)

(72) Inventors: Vivek G. GUPTA, San Jose, CA (US); Anikethan Ramakrishna VIJAYA KUMAR, Mysuru (IN); Basant KUMAR, Bangalore (IN); Nirlesh KOSHTA, Bangalore (IN); Shashanka TOTADAMANE RAMAPPA, Shivamogga (IN); Sridhar PRAKASAM, Fremont, CA (US)

(21) Appl. No.: 19/152,805

(22) PCT Filed: Jan. 8, 2024
(86) PCT No.: PCT/US2024/010724

§ 371 Date: Jul. 31, 2025

(30) Foreign Application Priority Data
Feb. 1, 2023 (IN) 202341006593

(51) Int. Cl. H04W 60/00; H04W 48/08

(52) U.S. Cl. CPC H04W 60/002; H04W 48/08

(57) ABSTRACT

Techniques for supporting network slice groups, such as Network Slice Simultaneous Registration Groups (NSRRGs) in a 5G telecommunications network are disclosed. The disclosed techniques enable robust support for network slice groups that can improve accessibility and efficiency of network slices, reduce incorrect configurations, and provide expanded capabilities versus conventional approaches. The techniques may be directed to one or more of utilizing a mode of communication (e.g., Evolved Packet Core) to enable support for network slicing groups on another mode of communication (e.g., 5G), managing network slicing group information in response to subscription changes, connecting to a network slice in a different group when connected to network slices in a first group via multiple access types (e.g., 3GPP and non-3GPP), managing pending and requested network slices, and synchronizing user equipment and network registrations status for different accesses.

### FIELD OF INVENTION

This disclosure related generally to wireless technology and more particularly to supporting network slice groups.

### BACKGROUND

In telecommunications, 5G is the fifth-generation technology standard for broadband cellular networks. Like its predecessors, 5G networks are cellular networks, in which the service area is divided into small geographical areas called cells. A mobile device moving from one cell to another is automatically handed off seamlessly. The 3rd Generation Partnership Project (3GPP) is the industry consortium that sets standards for 5G. The packet protocol for mobility management (establishing connection and moving between base stations) and session management (connecting to networks and network slices) in 5G are defined in TS 24.501. An air interface, or access mode, is the communication link between two stations in mobile or wireless communication. 5G New Radio (NR) is a radio access technology (RAT) developed by 3GPP to be the standard for the air interface of 5G networks. 5G NR deployments can be configured to utilize aspects of both 5GC and/or 4G LTE EPC networks.

In addition to increased speed and bandwidth, 5G provides new compared to 4G, such as network slicing. Network slicing is a network architecture that enables the multiplexing of virtualized and independent logical networks on the same physical network infrastructure. Each network slice is an isolated end-to-end network tailored to fulfil diverse requirements requested by a particular application. Network slicing plays a central role in supporting 5G mobile networks that are designed to efficiently embrace a plethora of services with very different service level requirements.

### BRIEF SUMMARY

Processes, machines, and articles of manufacture for supporting network slice groups are described. It will be appreciated that the embodiments may be combined in any number of ways without departing from the scope of this disclosure.

Embodiments may include receiving an information element via a first mode of communication, the information element indicating a network slice is available for provision on a second mode of communication, wherein the information element includes a network slice identifier corresponding to the network slice; updating a list of configured network slices to include the network slice identifier; and registering to utilize the network slice on the second mode of communication based on the network slice identifier.

Embodiments may include receiving an information element via a first mode of communication at a user equipment (UE) device, the information element indicating a network slice is available for provision on a second mode of communication, wherein the information element includes a network slice identifier corresponding to the network slice and group information corresponding to a network slice group including the network slice; updating a list of configured network slices to include the network slice identifier and the group information; and registering to utilize the network slice on the second mode of communication based on the network slice identifier and the group information.

Embodiments may include receiving, at a user equipment (UE) device, a new list of configured network slices during a UE Configuration Update procedure; failing to receive an information element (IE) with new group information associated with the list of configured network slices during the UE Configuration Update procedure; and deleting old group information in response to receiving the new list of configured network slices and failing to receive new group information associated with the list of configured network slices during the UE Configuration Update procedure.

Embodiments may include registering to a first network slice via a first access type, wherein the first network slice is included in a first network slice group; registering to a second network slice via a second access type, wherein the second network slice is included in the first network slice group; determining to register to a third network slice, wherein the third network slice is included in a second network slice group; and generating a registration request for the third network slice, wherein the registration request indicates the registration request is intentional.

Embodiments may include determining registering for a network slice in a list of pending network slices is no longer needed; initiating a mobility registration procedure with an Access and Mobility Management Function (AMF); and communicating to the AMF, during the mobility registration procedure, an indication that registration with the network slice is no longer needed.

Embodiments may include locally deregistering on a first access type at a user equipment (UE) device when the UE device is out of coverage for the first access type and a second access type; initiating a registration procedure with an Access and Mobility Management Function (AMF) when the UE device returns to coverage for the first or second access type; communicating to the AMF, during the registration procedure, the registration status of the UE regarding the first or second access type.

Other processes, machines, and articles of manufacture are also described hereby, which may be combined in any number of ways, such as with the embodiments of the brief summary, without departing from the scope of this disclosure.

### BRIEF DESCRIPTION OF THE DRAWINGS

The present invention is illustrated by way of example and not limitation in the figures of the accompanying drawings in which like references indicate similar elements. To easily identify the discussion of any particular element or act, the most significant digit or digits in a reference number refer to the figure number in which that element is first introduced.

FIG. 1 illustrates an example wireless communication system according to some embodiments.

FIG. 2 illustrates a base station (BS) in communication with a user equipment (UE) device according to some embodiments.

FIG. 3 illustrates an example block diagram of a UE according to some embodiments.

FIG. 4 illustrates an example block diagram of a BS according to some embodiments.

FIG. 5 illustrates an example block diagram of cellular communication circuitry, according to some embodiments.

FIGS. 6A and 6B illustrate various aspects of network slicing according to some embodiments.

FIG. 7 illustrates an example block diagram of network slice lists according to some embodiments.

FIG. 8 illustrates an exemplary operating environment according to some embodiments.

FIG. 9 illustrates an example block diagram of a network message according to some embodiments.

FIG. 10 illustrates an exemplary process diagram for slice group updates according to some embodiments.

FIGS. 11A and 11B illustrate logic flows of exemplary techniques for supporting network slicing groups according to some embodiments.

FIG. 12 illustrates a logic flow of an exemplary technique for supporting network slicing groups according to some embodiments.

FIG. 13 illustrates a logic flow of an exemplary technique for supporting network slicing groups according to some embodiments.

FIG. 14 illustrates a logic flow of an exemplary technique for supporting network slicing groups according to some embodiments.

FIG. 15 illustrates a logic flow of an exemplary technique for supporting network slicing groups according to some embodiments.

### DETAILED DESCRIPTION

Techniques for supporting network slice groups are described. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etcetera), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

Generally, this disclosure describes techniques for supporting network slice groups, such as Network Slice Simultaneous Registration Groups (NSRRGs) in a 5G telecommunications network. The subject matter described hereby provides many technical advantages. For instance, the computer-based techniques of the current disclosure improve the functioning of a telecommunications system as compared to conventional approaches because the techniques enable robust support for network slice groups that can improve accessibility and efficiency of network slices, reduce incorrect configurations, and provide expanded capabilities versus conventional approaches. Accordingly, embodiments disclosed hereby can be practically utilized to improve the functioning of a computer and/or to improve the technical fields of telecommunications and/or network slicing.

In several embodiments, the techniques are directed to utilizing one mode of communication (e.g., Evolved Packet Core (EPC) to enable support for network slicing groups on another mode of communication (e.g., 5G). In various embodiments, the techniques are directed to managing network slicing group information in response to subscription changes. In many embodiments, the techniques are directed to connecting to a network slice in a different group when connected to network slices in a first group via multiple access types (e.g., 3GPP and non-3GPP). In one or more embodiments, the techniques are directed to managing pending and requested network slices. In some embodiments, the techniques are directed to synchronizing user equipment and network registrations status for different accesses. It will be appreciated that various aspects of telecommunication networks, capabilities, protocols, and procedures relevant to the techniques described and terms referenced herein can be found in 3GPP technical specifications (TS), such as TS 24.501, TS 24.301, and TS 24.008.

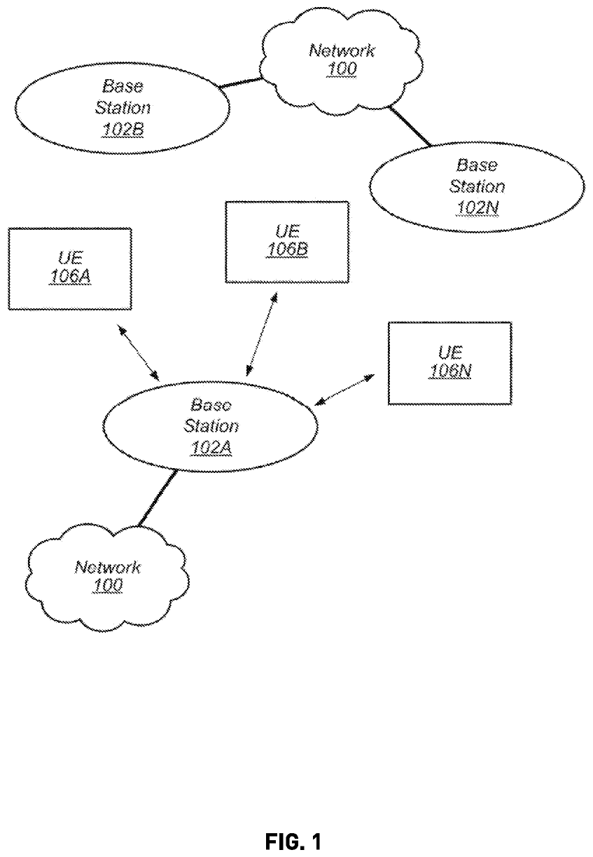

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etcetera, through 106N. Each of the user devices may be referred to herein as a “user equipment” (UE) or UE device. Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etcetera. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etcetera). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

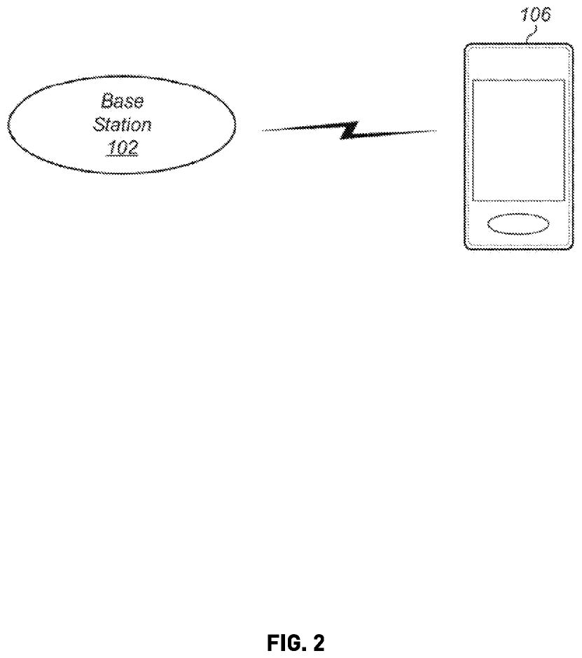

FIG. 2 illustrates user equipment 106 (e.g., one of the devices 106A through 106N) in communication with a base station 102, according to some embodiments. The UE 106 may be a device with cellular communication capability such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, 5G NR, CDMA2000 (1xRTT/1xEV-DO/HRPD/eHRPD), or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above. In various embodiments, a receive and/or transmit chain may comprise a cascade of electronic components and sub-units (e.g., amplifiers, filters, mixers, attenuators, detector, etcetera) utilized to receive and/or transmit signals, such as radio frequency signals.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTT or LTE or GSM), and separate radios for communicating using each of Wi-Fi and Bluetooth. Other configurations are also possible.

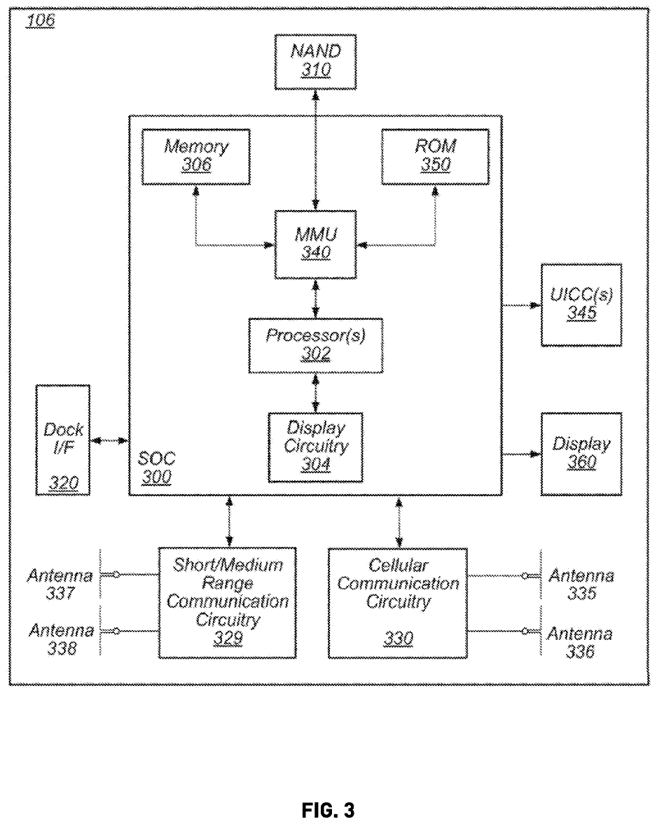

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly, dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may be configured to transmit a request to attach or register to a first network node operating according to the first RAT (e.g., 5G NR, 4G LTE, Bluetooth, Wi-Fi, etcetera) and transmit an indication that the wireless device is capable of maintaining substantially concurrent connections with the first network node and a second network node that operates according to the second RAT (e.g., 5G NR, 4G LTE, Bluetooth, Wi-Fi, etcetera). The wireless device may also be configured transmit a request to attach or register to the second network node. The request may include an indication that the wireless device is capable of maintaining substantially concurrent connections with the first and second network nodes. Further, the wireless device may be configured to receive an indication that dual connectivity with the first and second network nodes has been established.

As described herein, the communication device 106 may include hardware and software components for implementing the above features for supporting network slicing groups. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etcetera) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etcetera) configured to perform the functions of cellular communication circuitry 330. Similarly, the short range wireless communication circuitry 329 may include one or more ICs that are configured to perform the functions of short range wireless communication circuitry 329. In addition, each integrated circuit may include circuitry (e.g., first circuitry, second circuitry, etcetera) configured to perform the functions of short range wireless communication circuitry 329.

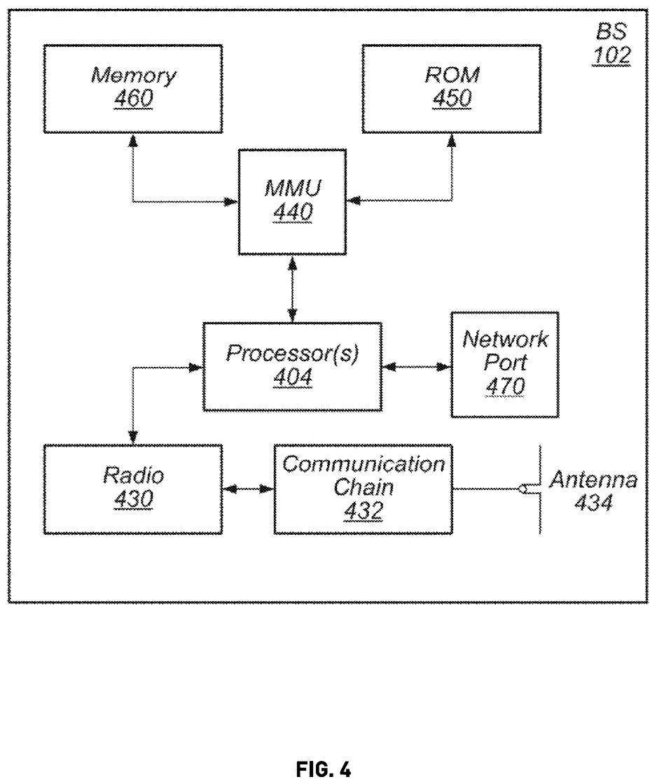

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a 5G CN core (5G CN) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

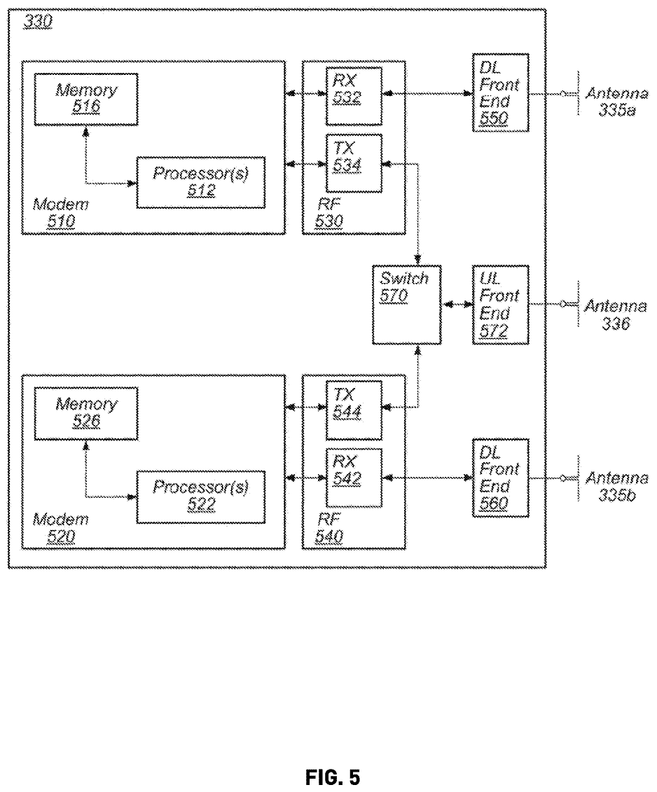

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 330 may be include in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown. In some embodiments, cellular communication circuitry 330 may include dedicated receive chains (including and/or coupled to, e.g., communicatively; directly or indirectly, dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for supporting network slicing groups, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for supporting network slicing groups, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

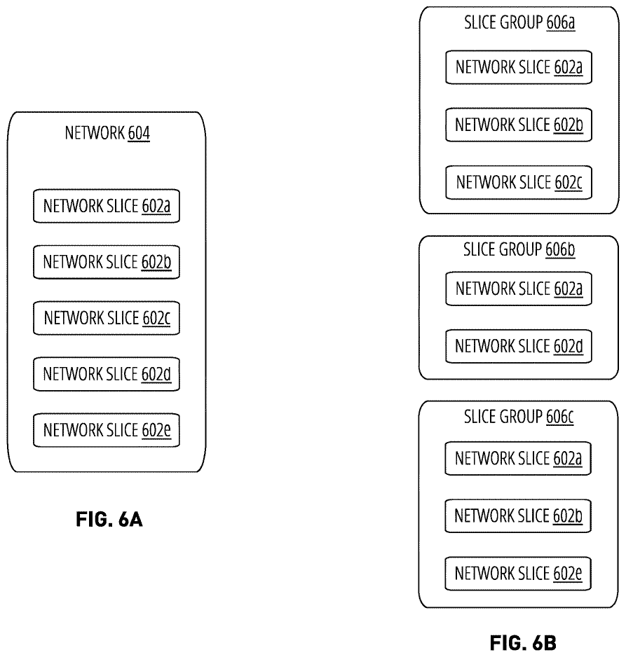

FIGS. 6A and 6B illustrate various aspects of network slicing according to one or more embodiments. More specifically, FIG. 6A illustrates a network 604 with a plurality of network slices 602a, 602b, 602c, 602d, 602e (collectively referred to as network slices 602); and FIG. 6B illustrates a plurality of slice groups 606a, 606b, 606c (collectively referred to as slice groups 606). In the illustrated embodiment, slice group 606a includes network slices 602a, 602b, 602c, slice group 606b includes network slices 602a 602d, and slice group 606c includes network slices 602a, 602b, 602e. Various embodiments described hereby may be directed to supporting network slicing and network slice groups for use by UEs. Embodiments are not limited in this context.

Networks (i.e., network 604), such as telecommunication networks may overlay multiple virtual networks (i.e., network slices 602) on a set of shared network and computing resources. Each of the network slices 602 may include different features, such as logical topologies, security rules, and/or performance characteristics. Typically, different slices are created for different purposes, such as ensuring quality of service (QoS) or isolating traffic for specific users or device classes. For example, network slice 602a may be configured for voice and video, network slice 602b may be configured for internet of things (IoT), network slice 602c may be configured for autonomous vehicles, network slice 602d may be utilized for factory automation, and network slice 602e may be utilized for physical infrastructure.

The network slices utilized by 5G include Enhanced Mobile Broadband (eMBB), Massive Machine-Type Communications (mMTC), and Ultrareliable Low-Latency Communications (URLLC). In various embodiments, eMBB may provide mobile data access to dense collections of users, to highly mobile users, and to widely spread users. In some embodiments, mMTC may serve massive numbers of devices in a small area with the expectation that they generate small amounts of data (e.g., tens of bytes per second) and can tolerate high latency (e.g., 10 seconds). In many embodiments, URRLC may deliver secure communications with small latencies (e.g., <1 millisecond) and high reliability with low, or even zero, packet loss. In many embodiments, each of the network slices 602 may refer to, or include, a Single-Network Slice Selection Assistance information (S-NSSAI).

Referring to FIG. 6B, oftentimes, UEs can simultaneously use multiple different network slices. In various embodiments, slice groups 606 define which network slices can be simultaneously used by (or provided to) a UE. For instance, in the illustrated embodiment, a UE could simultaneously utilize network slices 602a, 602b, 602c from slice group 606a, network slices 602a, 602d from slice group 606b, or network slices 602a, 602b, 602e. However, in the illustrated embodiment, a UE could not simultaneously utilize network slices 602d, 602e or network slices 602c, 602d. It will be appreciated that any number/combination of network slices and/or network slice groups that can be supported by the network infrastructure can be utilized without departing from the scope of this disclosure. In many embodiments, each of the slice groups 606 may refer to, or include, a Network Slice Simultaneous Registration Group (NSSRG). A UE may indicate its support for NSSRG in a 5G mobility management (5GMM) Capability information element (IE).

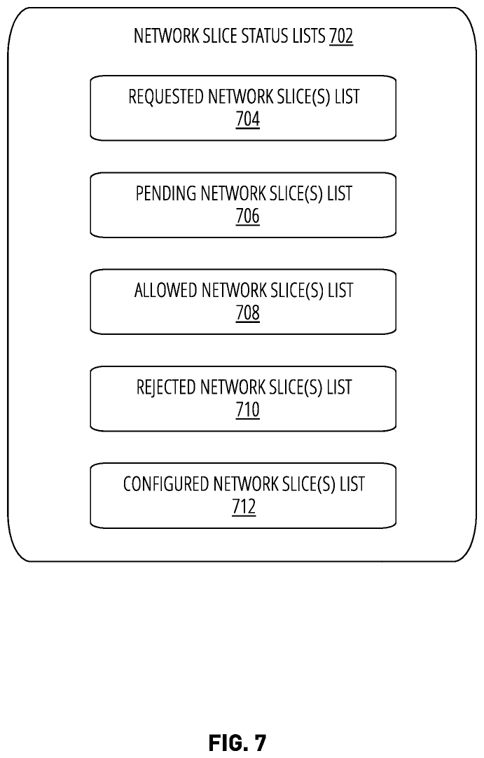

FIG. 7 illustrates a set of network slice lists 702 according to one or more embodiments. In many embodiments, these slice lists may be used during communication between UE and the network. In the illustrated embodiment, network slice lists 702 include a requested network slice(s) list 704, a pending network slice(s) list 706, an allowed network slice(s) list 708, a rejected network slice(s) list 710, and a configured network slice(s) list 712. The requested network slice(s) list 704 may include a set of network slices a UE requests to use in a registration request. The pending network slice(s) list 706 may include a set of network slices that have been requested by the UE but cannot be used by the UE as authentication of these slices by the network is pending. The allowed network slice(s) list 708 may include a set of network slices that are allowed for use of the UE by the network. In many embodiments, the allowed network slice(s) list 708 only includes network slices from a common slice group. The rejected network slice(s) list 710 may include a set of network slices that are rejected by the network (e.g., due to insufficient resources). The configured network slice(s) list 712 may include a set of network slices that the UE is subscribed to. In many embodiments, the configured network slice(s) list 712 is provided by the Public Land Mobile Network (PLMN) or Home PLMN (HPLMN) of the UE. One or more of the network slice lists 702 may include slice group information corresponding to one or more of the included network slices.

In various embodiments, the requested network slice(s) list 704 may refer to, or include, a Requested NSSAI. In various such embodiments, the Requested NSSAI may identify one or more S-NSSAIs and be included by the UE as part of a REGISTRATION REQUEST message communicated to the network regarding the one or more S-NSSAIs.

In some embodiments, the pending network slice(s) list 706 may refer to, or include, a Pending NSSAI. In some such embodiments, the Pending NSSAI may identify one or more S-NSSAIs that were included in the Requested NSSAI network message, but that have not been indicated as allowed or rejected by the network and have instead been included in the pending NSSAI list.

In many embodiments, the allowed network slice(s) list 708 may refer to, or include, an Allowed NSSAI. In many such embodiments, the Allowed NSSAI may identify one or more S-NSSAIs that were included in the Requested NSSAI network message and that were allowed in a REGISTRATION ACCEPT message received by the UE from the network. The Allowed NSSAI may only include S-NSSAIs that share a common group (e.g., NSSRG) and can work simultaneously together.

In several embodiments, the rejected network slice(s) list 710 may refer to, or include, a Rejected NSSAI. In several such embodiments, the Rejected NSSAI may identify one or more S-NSSAIs that were included in the Requested NSSAI network message and that were rejected in a REGISTRATION REJECT message received by the UE from the network.

In various embodiments, the configured network slice(s) list 712 may refer to, or include a Configured NSSAI. In various such embodiments, the Configured NSSAI may be provided by the HPLMN or the visitor PLMN and be stored in the UE. The Configured NSSAI may be based on UE subscriptions and other operator deployment options. The Configured NSSAI may include one or more NSSRGs associated with one or more of the included S-NSSAIs.

The NSSRG defines which S-NSSAIs can be simultaneously provided to the UE in the Allowed NSSAI. If there are no NSSRG restrictions in the UE subscription (e.g., availability at a specific location, congestion based constraints on available slices, etcetera) then all network slices (S-NSSAI(s)) in UE subscription can be simultaneously be provided to UE in the allowed NSSAI. However, if NSSRG restrictions are present in the UE subscription, then each S-NSSAI in the UE subscription has NSSRG information associated with it. In many embodiments, the UE can only use those slices that belong to the same NSSRG in allowed NSSAI with applications during PDN connection establishment.

In various embodiments, the network includes a mobility manager with a function (e.g., an Access and Mobility Management Function (AMF) and/or a Network Slice Selection Function (NSSF) that evaluates S-NSSAIs in a received Requested NSSAI as part of REGISTRATION REQUEST message based on applicable NSSRG information and determines what network slices can be provided to the UE that work together, enabling determination of the allowed and rejected NSSAIs. In many embodiments, the allowed NSSAI only includes S-NSSAI(s) that share a NSSRG (common slice group). When the AMF provides a Configured NSSAI to a UE, it may include NSSRG information for each of the included network slices (i.e., S-NSSAI(s) in the Configured NSSAI.

When a UE requests slices in a Requested NSSAI, it includes only those slices that share a common NSSRG. If the NSSRG information changes in the UE subscription, a user data manager (e.g., Unified Data Management (UDM)) updates the mobility manager (e.g., AMF) with the new NSSRG information. The mobility manager then updates the Configured NSSAI in the UE and associated NSSRG information using the UE Configuration Update procedure.

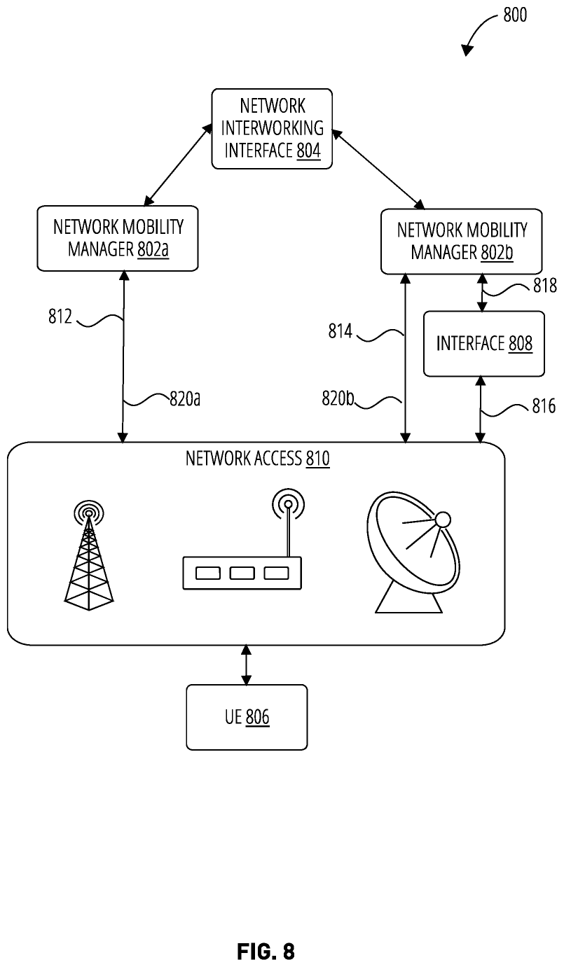

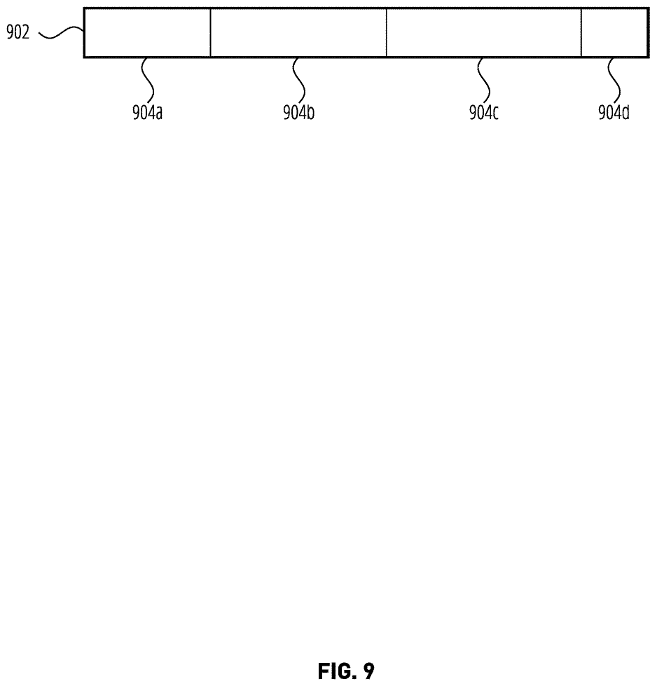

FIG. 8 illustrates an exemplary operating environment 800 according to one or more embodiments. Operating environment 800 includes a UE 806, a network access 810, network mobility managers 802a, 802b (collectively referred to as network mobility managers 802), network interworking interface 804, and interface 808. In various embodiments, the components of operating environment 800 may interoperate to provide support to network slices and network slice groups. In various such embodiments, the support to network slices and network slice groups may utilize one or more modes of communication, access types, networks, and the like. Embodiments are not limited in this context.

In many embodiments, a first mode of communication may utilize network mobility manager 802a and a second mode of communication may utilize network mobility manager 802b. The first mode of communication may refer to S1 mode access 812 using evolved packet core (EPC) in Evolved Packet System (EPS) and the second mode of communication may refer to N1 mode access 814 (or N2 mode access 818) using 5G Core Network (CN). Accordingly, in many embodiments, the network mobility manager 802a may refer to, or include, a Mobility Management Entity (MME) and/or a Home Selection Service (HSS) and the network mobility manager 802b may refer to, or include, an AMF and/or UDM. Additionally, the first mode of communication may support 3GPP access 820a and the second mode of communication may support multiple access types, such as 3GPP access 820b and non-3GPP access 816. In the illustrated embodiment, the non-3GPP access 816 may utilize interface 808 to gain N2 mode access 818 to a 5G CN. For example, the non-3GPP access 816 may refer to Wi-Fi and/or Bluetooth access.

In various embodiments, the network interworking interface 804 may facilitate the transfer of information, such as statuses, identifiers, and the like, between the different modes of communications. For example, as will be discussed in more detail below, using a first mode of communication to communicate the availability of a network slice on the second mode of communication. In some embodiments, network access 810 may represent various Radio Access Technologies (RATs) utilized by the UE 806 to access the networks of the network mobility manager 802a and/or network mobility manager 802b. For example, the RATs may include one or more of Bluetooth, Wi-Fi, GSM, UMTS, LTE, and 5G NR.

FIG. 9 illustrates a network message 902 comprising a plurality of information elements (IEs) 904a, 904b, 904c, 904d (collectively referred to as IEs 904). In various embodiments, a variety of network messages 902 composed of one or more information elements may be utilized for communication between different components (e.g., UEs and network mobility managers). For example, one or more network message 902 of one or more formats may be exchanged between the one or more UEs and one or more network components to perform one or more procedures, such as UE Configuration Update procedures, the Connection Establishment procedures, Mobility Registrations procedures, and Registration procedures. In some embodiments, network messages may simply be referred to as messages. It will be appreciated that the network message 902 and IEs 904 may come in a variety of formats and carry a variety of information. Oftentimes, various standards and technical specifications define the various network messages 902 902, IEs 904, and procedures, such as 3GPP technical specifications (e.g., TS 24.501, TS 24.301, TS 24.008, etcetera). Embodiments are not limited in this context.

Various embodiments described hereby may enable support for network slice groups (e.g., NSSRGs) in S1 mode. In various such embodiments, the support may improve transitions from N1 mode to S1 mode and back to N1 mode based on network slice availability. For example, when a UE using NR and connected to 5G CN tries to use a network slice the network (e.g., network mobility manager 802b) may reject its use. This may happen because the current network slice (e.g., S-NSSAI) may not be available for the current PLMN or a Stand-alone Non-Public Network (SNPN) or in the current Tracking Area (TA) or registration area. In such cases the network may return cause code #62 (no network slices available). The S-NSSAI may then be added to the rejected NSSAI list (e.g., rejected network slice(s) list 710).

In this case, the UE may disable N1 mode (e.g., N1 mode access 814) and try to use S1 mode (e.g., S1 mode access 812) by registering to Evolved Packet System (EPS) using LTE. Subsequently, the network slice (e.g., S-NSSAI) may become available, such as due to less network congestion, the UE moving to a different tracking area, etcetera). In such cases, when the UE using LTE and connected to EPS tries to create a Packet Data Network (PDN) connection, the UE may receive such a notification of availability of previously rejected network slice from the network in the extended Protocol Configuration Options (ePCO) IE. The UE may then remove the slice from the list of Rejected NSSAIs and place it in the Configured NSSAI as per 3GPP TS 24.501.

However, with existing techniques in S1 mode, the UE can only receive network slice identifiers (e.g., S-NSSAI values) as part of Protocol Configuration Options (PCO) information element, but not the corresponding group information (e.g., NSSRG information). However, updating the Configured NSSAI with a new S-NSSAI received in S1 mode can lead to a case where some S-NSSAI(s) in the Configured NSSAI have associated NSSRG values and some do not, leading to a Configured NSSAI with an inconsistent NSSRG configuration. However, according to TS 24.501, it is expected that all S-NSSAI(s) in the configured NSSAI have associated NSSRG values.

Accordingly, embodiments of the current disclosure are directed to preventing inconsistent NSSRG configurations resulting from switching from a first mode of communication (e.g., N1 mode) to a second mode of communication (e.g., S1 mode) and back to the first mode of communication. In some embodiments, this includes the network providing corresponding group information (e.g., NSSRG values) for a network slice (S-NSSAI) that is added to the configured network slice list (e.g., Configured NSSAI) when the network slice is provided to the UE in S1 mode for inclusion in the configured network slice list. In such embodiments, once this is done, the UE can enable NR RAT, transition to N1 mode and start using the network slice with NR in 5G CN.

As described in more detail below, a first solution to preventing inconsistent NSSRG configurations resulting from switching from a first mode of communication (e.g., N1 mode) to a second mode of communication (e.g., S1 mode) and back to the first mode of communication may include: (1) the network only providing the S-NSSAI without any NSSRG information in S1 mode; (2) the UE storing the provided S-NSSAI in Configured NSSAI; (3) when transitioning to N1 mode and during registration procedure, the UE includes the provided S-NSSAI in S1 mode from Configured NSSAI in the Requested NSSAI and lets the network mobility manager (e.g., AMF) determine the appropriate NSSRG value; and (4) the network mobility manager then updates the NSSRG values and provides a new Configured NSSAI to the UE using the UE Configuration Update procedure by sending the CONFIGURATION UPDATE COMMAND message.

In various embodiments, this solution may result in TS 24.501 with modifications including the following regarding initial registration initiation. The subset of configured NSSAI provided in the requested NSSAI includes one or more S-NSSAIs in the configured NSSAI applicable to the current PLMN or SNPN, if the S-NSSAI is neither in the rejected NSSAI nor associated to the S-NSSAI(s) in the rejected NSSAI. In addition, if the NSSRG information is available, the subset of configured NSSAI provided in the requested NSSAI shall be associated with at least one common NSSRG value. The UE may also include in the requested NSSAI, S-NSSAI(s) which were added to configured NSSAI when the UE was in S1 Mode and for which the associated NSSRG value is not yet available. If the UE is in 5GMM-REGISTERED state over the other access and has already an allowed NSSAI for the other access, all the S-NSSAI(s) in the requested NSSAI for the current access shall share at least an NSSRG value common to all the S-NSSAI(s) of the allowed NSSAI for the other access. If the UE is simultaneously performing the registration procedure on the other access, then the UE shall include S-NSSAIs that share at least a common NSSRG value across all access types.

Additionally, in some embodiments, this solution may result in TS 24.501 with modifications including the following regarding mobility and periodic registration update initiation. The subset of configured NSSAI provided in the requested NSSAI consists of one or more S-NSSAIs in the configured NSSAI applicable to this PLMN or SNPN, if the S-NSSAI is neither in the rejected NSSAI nor associated to the S-NSSAI(s) in the rejected NSSAI. In addition, if the NSSRG information is available, the subset of configured NSSAI provided in the requested NSSAI shall be associated with at least one common NSSRG value. The UE may also include in the requested NSSAI, S-NSSAI(s) which were added to configured NSSAI when the UE was in S1-Mode and for which the associated NSSRG value is not yet available. If the UE is in 5GMM-REGISTERED state over the other access and has already an allowed NSSAI for the other access, all the S-NSSAI(s) in the requested NSSAI for the current access shall share at least an NSSRG value common to all the S-NSSAI(s) of the allowed NSSAI for the other access. If the UE is simultaneously performing the registration procedure on the other access, the UE shall include S-NSSAIs that share at least a common NSSRG value across all access types.

As described in more detail below, a second solution to preventing inconsistent NSSRG configurations resulting from switching from a first mode of communication (e.g., N1 mode) to a second mode of communication (e.g., S1 mode) and back to the first mode of communication may include: (1) providing support for NSSRG in PCO or ePCO such that the UE indicates support of NSSRG and the network provides NSSRG information when an S-NSSAI is to be added to the Configured NSSAI; (2) the UE storing the NSSRG information associated with S-NSSAI provided in PCO or ePCO; and (3) the UE shall store the received NSSRG information along with any S-NSSAI values in the Configured NSSAI.

In many embodiments, support for network slice groups (e.g., NSSRG) may be provided in the PCO IE. The UE may indicate support of network slice groups and the network may provide group information (e.g., NSSRG information) when a network slice (e.g., S-NSSAI) is to be added to the configured network slice(s) list (e.g., Configured NSSAI). In some embodiments, this may be accomplished, at least in part, using the additional parameters list (octets w+1 to za) of the PCO as defined in TS 24.008 with modifications. The additional parameters list is included when special parameters and/or requests (e.g., associated with a PDP context) need to be transferred between the UE and the network. These parameters and/or requests are not related to a specific configuration protocol, and therefore are not encoded as the “Packets” contained in the configuration protocol options list. The additional parameters list contains a list of special parameters, each one in a separate container. The type of the parameter carried in a container is identified by a specific container identifier. In this version of the protocol, the following container identifiers are specified.

UE to network direction: 004BH (NSSRG support indicator). Network to UE direction: 004BH (NSSRG information indicator). When the container identifier indicates NSSRG support indicator, the container identifier contents field is empty and the length of container identifier contents indicates a length equal to zero. If the container identifier contents field is not empty, it shall be ignored. This information indicates that the UE supports NSSRG as specified in 3GPP TS 24.501 [167]. When the container identifier indicates NSSRG information indicator, the container identifier contents field contains NSSRG information followed by one PLMN ID that the NSSRG information relates to. The NSSRG information is encoded as specified in subclause 9.11.3.82 of TS 24.501 [167]. The PLMN ID is encoded as the value of the PLMN identity of the CN operator IE in subclause 10.5.5.36. The usage of the NSSRG and the associated PLMN is specified in TS 24.501 [167].

In various embodiments, the UE will store the NSSRG information associated with S-NSSAI provided in PCO or ePCO. Accordingly, this solution may result in TS 24.301 with modifications including the following. Upon receipt of the Activate Default EPS Bearer Context Request message, if an S-NSSAI, the PLMN ID and NSSRG information (if any) that this S-NSSAI relates to are provided in the PCO IE or ePCO IE, the UE may delete the stored S-NSSAI, the PLMN ID and NSSRG information that this S-NSSAI relates to, if any, and shall store the S-NSSAI, the PLMN ID along with the NSSRG information this S-NSSAI relates to that is provided in the Activate Default EPS Bearer Context Request message and the associated PLMN ID along with the corresponding PDU session ID that the UE provided in the PDN Connectivity Request message. The usage of the PDU session ID and the corresponding S-NSSAI with the associated PLMN ID and NSSRG information is specified in 3GPP TS 24.501 [54].

Additionally, the UE may store the received NSSRG information along with any S-NSSAI values in the Configured NSSAI. Accordingly, this solution may result in TS 24.501 with modifications including the following. If the UE receives an S-NSSAI associated with a PLMN ID, and associated NSSRG information from the network during the PDN connection establishment procedure in EPS as specified in 3GPP TS 24.301 or via ePDG as specified in 3GPP TS 24.302 [16], the UE may store the received S-NSSAI in the configured NSSAI for the PLMN identified by the PLMN ID associated with the S-NSSAI, if not already included in the configured NSSAI along with the associated NSSRG information.

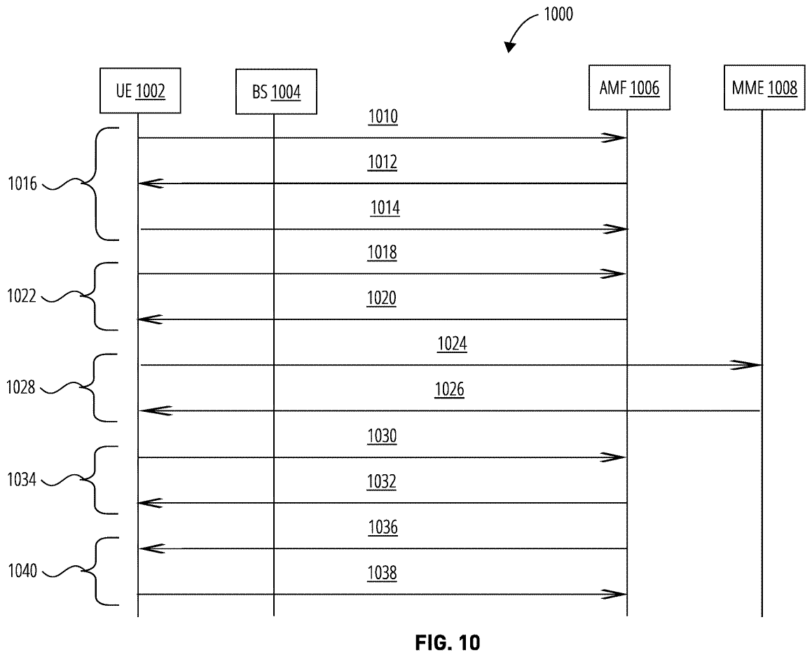

FIG. 10 illustrates a process diagram 1000 for slice group updates according to some embodiments. The process diagram 1000 may relate to preventing inconsistent NSSRG configurations resulting from switching from a first mode of communication (e.g., N1 mode) to a second mode of communication (e.g., S1 mode) and back to the first mode of communication. In various embodiments, some aspects of process diagram 1000 may specifically relate to the second solution described above. Process diagram 1000 includes the exchange of network messages 1010, 1012, 1014, 1018, 1020, 1024, 1026, 1030, 1032, 1036, 1038 between various components 1002, 1004, 1006, 1008 to perform a plurality of procedures 1016, 1022, 1028, 1034, 1040. The various components may include a UE 1002, a BS 1004, an AMF 1006, and an MME 1008. The plurality of procedures may include registration procedure 1016, mobility registration procedure 1022, connection establishment procedure 1028, mobility registration procedure 1034, and configuration update procedure 1040. Embodiments are not limited in this context.

The registration procedure 1016 may include the exchange of three messages 1010, 1012, 1014. The first message may include a REGISTRATION REQUEST message 1010 sent from the UE 1002 to the AMF 1006. The REGISTRATION REQUEST message 1010 may include 5GMM capability of the UE. In response to the REGISTRATION REQUEST message 1010, the AMF 1006 may send a REGISTRATION ACCEPT message 1012 to the UE 1002. The REGISTRATION ACCEPT message 1012 may include a Configured NSSAI and group information (NSSRG). In various embodiments, the AMF 1006 may receive the network slice group configuration and NSSRG information from subscription information (e.g., via UDM). In response to the REGISTRATION ACCEPT message 1012, the UE 1002 may locally store the Configured NSSAI and associated NSSRG information. Additionally, the UE 1002 may send a Registration Complete message 1014 to the AMF 1006. The registration procedure 1016 may result in the UE 1002 being registered on NR RAT.

The mobility registration procedure 1022 may include the exchange of two messages 1018, 1020. The first message may include a Mobility REGISTRATION REQUEST message 1018 sent from the UE 1002 to the AMF 1006. The Mobility REGISTRATION REQUEST message 1018 may include the Requested NSSAI(s). In response and due to network slice unavailability (e.g., due to congestion), the AMF 1006 may send a Registration Reject message 1020 to the UE 1002 indicating the rejected NSSAI(s) and a cause (e.g., Cause #62). Following this, the UE 1002 may disable NR RAT and perform LTE attach (switching from N1 mode to S1 mode).

After the LTE Attach, a connection establishment procedure 1028 may be performed. The connection establishment procedure 1028 may include the exchange of two messages 1024, 1026. The first message may include a PDN CONNECTIVITY REQUEST message 1024 sent from the UE 1002 to the MME 1008. In response and due to the previously rejected network slice becoming available, the MME 1008 may send an Activate EPS Bearer Context Request message 1026 to the UE 1002 that indicates the S-NSSAI and NSSRG information via the PCO IE of the Activate EPS Bearer Context Request message 1026. In response to the Activate EPS Bearer Context Request message 1026, the UE 1002 may store/update the Configured NSSAI with the S-NSSAI and NSSRG information in S1 mode. Following this, the UE 1002 may reenable NR RAT, perform 5GS registration, and transition back to N1 mode.

After transitioning back to N1 mode, a second mobility registration procedure 1034 may be performed. The mobility registration procedure 1034 may include the exchange of two messages 1030, 1032. The first message may include a Mobility REGISTRATION REQUEST message 1030 including the Requested NSSAI sent by the UE 1002 to the AMF 1006. The UE request may now be accepted as network slice in the Requested NSSAI are available. Accordingly, in response to the Mobility REGISTRATION REQUEST message 1030, the AMF 1006 may send a Mobility REGISTRATION ACCEPT message 1032 with the Allowed NSSAI to the UE 1002. The UE 1002 then receives the Allowed NSSAI and can start using network slices in NR and do data transfer.

Subsequently, a configuration update procedure 1040 may be performed to update the Configured NSSAI on the UE 1002. The configuration update procedure 1040 may include the exchange of two messages 1036, 1038. The first message may include a CONFIGURATION UPDATE COMMAND message 1036 with the configured NSSAI and NSSRG information. The CONFIGURATION UPDATE COMMAND message 1036 may be sent in response to the network updating the configured NSSAI and/or associated NSSRG information. In response to the CONFIGURATION UPDATE COMMAND message 1036, the UE 1002 may store the updated Configured NSSAI and associated NSSRG information locally in N1 mode and send a Configuration Update Complete message 1038 back to the AMF 1006.

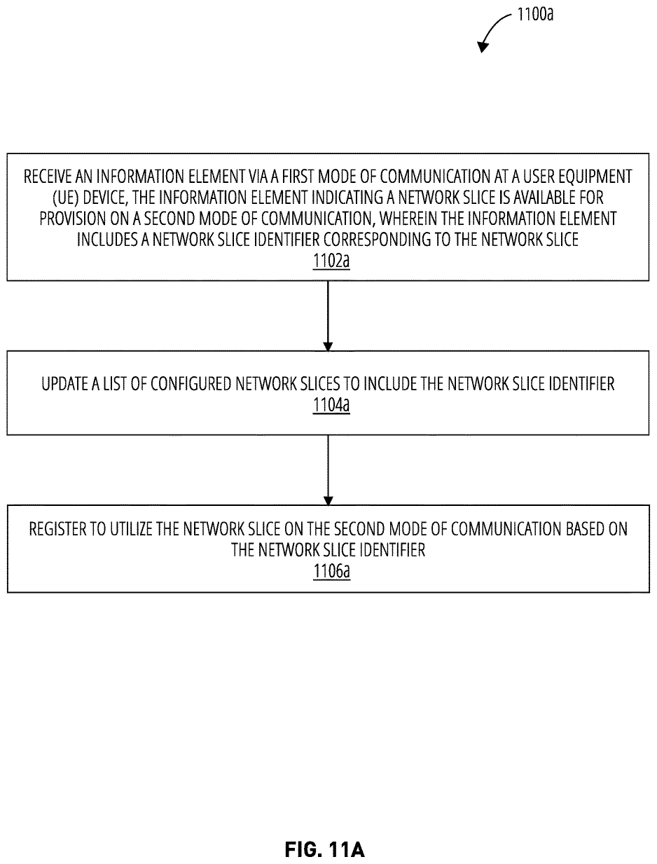

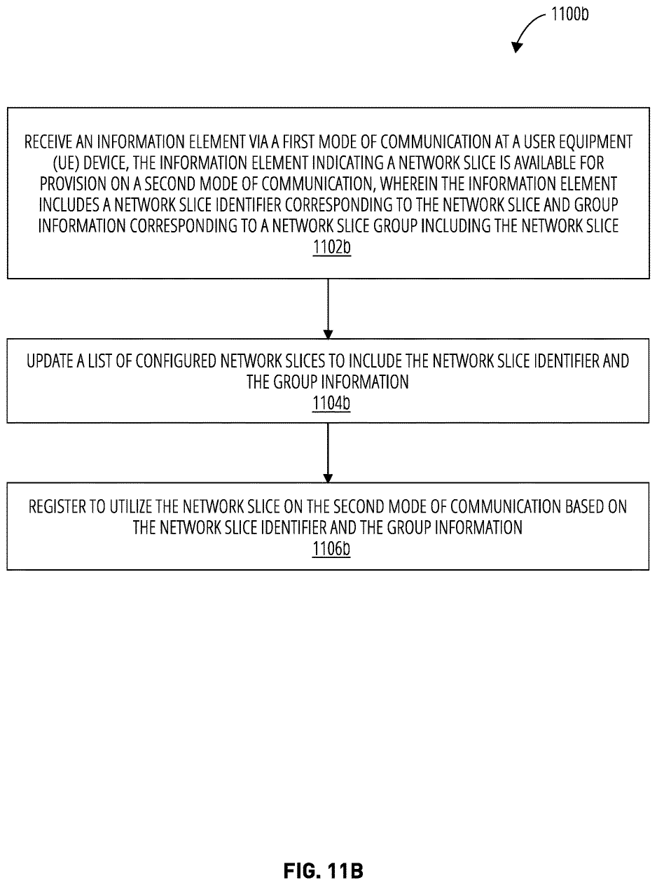

FIGS. 11A and 11B illustrate logic flows for supporting network slicing according to some embodiments. More specifically, the logic flows 1100a, 1100b may relate to preventing inconsistent NSSRG configurations resulting from switching from a first mode of communication (e.g., N1 mode) to a second mode of communication (e.g., S1 mode) and back to the first mode of communication. In various embodiments, some aspects of logic flow 1100a may particularly relate to the first solution described above and some aspects of logic flow 1100b may particularly relate to the second solution described above.

Referring to FIG. 11A, logic flow 1100a may begin at block 1102a. Block 1102a may include receiving an information element via a first mode of communication at a user equipment (UE) device, the information element indicating a network slice is available for provision on a second mode of communication, wherein the information element includes a network slice identifier corresponding to the network slice. For example, UE 1002 may receive Activate EPS Bearer Context Request message 1026 from 1008 via S1 mode indicating that an S-NSSAI is available on the N1 mode.

Continuing to block 1104a, a list of configured network slices may be updated to include the network slice identifier. For example, the UE 1002 may update the Configured NSSAI to include the S-NSSAI that is available.

Proceeding to block 1106a, the network slice on the second mode of communication may be registered for use based on the network slice identifier. For example, UE 1002 may communicate Mobility REGISTRATION REQUEST message 1030 with the S-NSSAI included in the Requested NSSAI. In many such embodiments, the AMF determines the appropriate NSSRG value and provides a new Configured NSSAI to the UE using the UE Configuration update procedure 1040.

Referring to FIG. 11B, logic flow 1100b may begin at block 1102b. Block 1102b may include receiving an information element via a first mode of communication at a user equipment (UE) device, the information element indicating a network slice is available for provision on a second mode of communication, wherein the information element includes a network slice identifier corresponding to the network slice and group information corresponding to a network slice group including the network slice. For example, UE 1002 may receive Activate EPS Bearer Context Request message 1026 from 1008 via S1 mode indicating that an S-NSSAI is available on the N1 mode along with corresponding NSSRG information.

Continuing to block 1104b, a list of configured network slices may be updated to include the network slice identifier and the group information. For example, the UE 1002 may update the Configured NSSAI to include the S-NSSAI that is available along with the corresponding NSSRG information.

Proceeding to block 1106b, the network slice on the second mode of communication may be registered for use based on the network slice identifier. For example, UE 1002 may communicate Mobility REGISTRATION REQUEST message 1030 with the S-NSSAI and the NSSRG included in the Requested NSSAI.

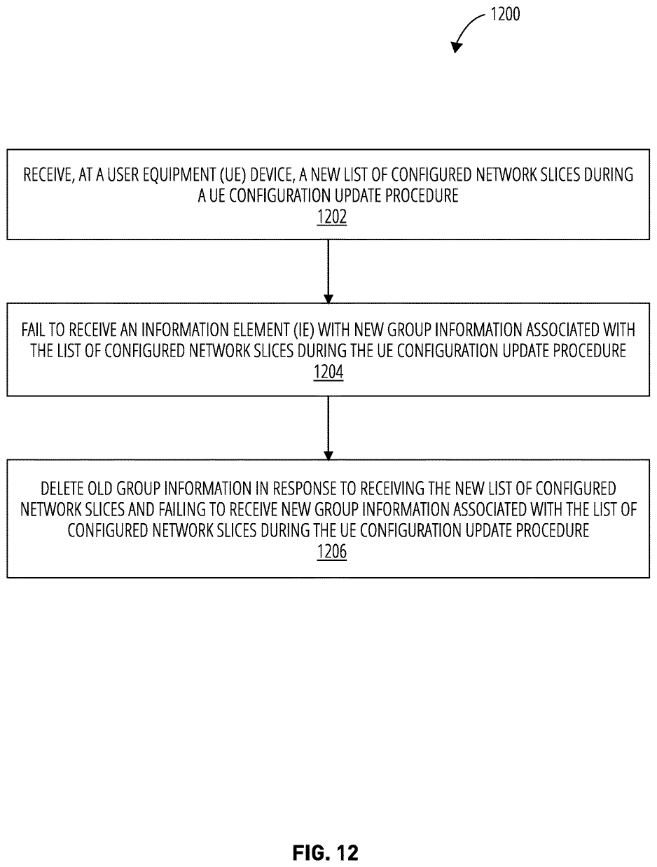

FIG. 12 illustrates a logic flow 1200 for supporting network slicing according to some embodiments. More specifically, the logic flow 1200 may relate to deleting stored network slice group information, such as due to subscription changes. With existing techniques, the network can provide new NSSRG information to the UE along with new Configured NSSAI or even otherwise. However, if the UE does not receive any NSSRG information along with the new Configured NSSAI, the UE will not delete any old already stored NSSRG information. Accordingly, one or more embodiments described hereby may, if the UE receives a new Configured NSSAI in the CONFIGURATION UPDATE COMMAND message or REGISTRATION ACCEPT message and no associated NSSRG information IE, cause the UE to delete any stored NSSRG information. Embodiments are not limited in this context.

The logic flow 1200 begins at block 1202. At block 1202 a new list of configured network slices may be received, at a UE device, during a UE Configuration Update procedure. Proceeding to block 1204 an information element (IE) with new group information associated with the list of configured network slices may fail to be received during the UE Configuration Update procedure. For example, CONFIGURATION UPDATE COMMAND message 1036 of configuration update procedure 1040 received by UE 1002 may fail to include new group information associated with the list of configured network slices.

Continuing to block 1206 old group information may be deleted in response to receiving the new list of configured network slices and failing to receive new group information associated with the list of configured network slices during the UE Configuration Update procedure. For example, UE 1002 may delete old group information stored locally.

In various embodiments, the solution described with respect to FIG. 12 may result in TS 24.501 with modifications including the following regarding generic UE configuration update accepted by the UE. If the UE receives a new configured NSSAI in the CONFIGURATION UPDATE COMMAND message, the UE shall consider the new configured NSSAI for the registered PLMN or SNPN as valid and the old configured NSSAI for the registered PLMN or SNPN as invalid; otherwise, the UE shall consider the old configured NSSAI for the registered PLMN or SNPN as valid. The UE shall store the new configured NSSAI as specified in subclause 4.6.2.2. In addition, if the CONFIGURATION UPDATE COMMAND message contains an NSSRG information IE, the UE shall store the contents of the NSSRG information IE as specified in subclause 4.6.2.2. If the UE receives a new configured NSSAI in the CONFIGURATION UPDATE COMMAND message and no NSSRG information IE, the UE shall delete any stored NSSRG information as specified in subclause 4.6.2.2.

In many embodiments, this solution may result in TS 24.501 with modifications including the following regarding initial registration accepted by the network. If the REGISTRATION ACCEPT message contains a configured NSSAI IE with a new configured NSSAI for the current PLMN or SNPN and optionally the mapped S-NSSAI(s) for the configured NSSAI for the current PLMN or SNPN, the UE shall store the contents of the configured NSSAI IE as specified in subclause 4.6.2.2. In addition, if the REGISTRATION ACCEPT message contains an NSSRG information IE, the UE shall store the contents of the NSSRG information IE as specified in subclause 4.6.2.2. If the UE receives a new configured NSSAI in the REGISTRATION ACCEPT message and no NSSRG information IE, the UE shall delete any stored NSSRG information as specified in subclause 4.6.2.2.

In several embodiments, this solution may result in TS 24.501 with modifications including the following regarding mobility and periodic registration update accepted by network. If the REGISTRATION ACCEPT message contains a configured NSSAI IE with a new configured NSSAI for the current PLMN or SNPN and optionally the mapped S-NSSAI(s) for the configured NSSAI for the current PLMN or SNPN, the UE shall store the contents of the configured NSSAI IE as specified in subclause 4.6.2.2. In addition, if the REGISTRATION ACCEPT message contains an NSSRG information IE, the UE shall store the contents of the NSSRG information IE as specified in subclause 4.6.2.2. If the UE receives a new configured NSSAI in the REGISTRATION ACCEPT message and no NSSRG information IE, the UE shall delete any stored NSSRG information as specified in subclause 4.6.2.2.

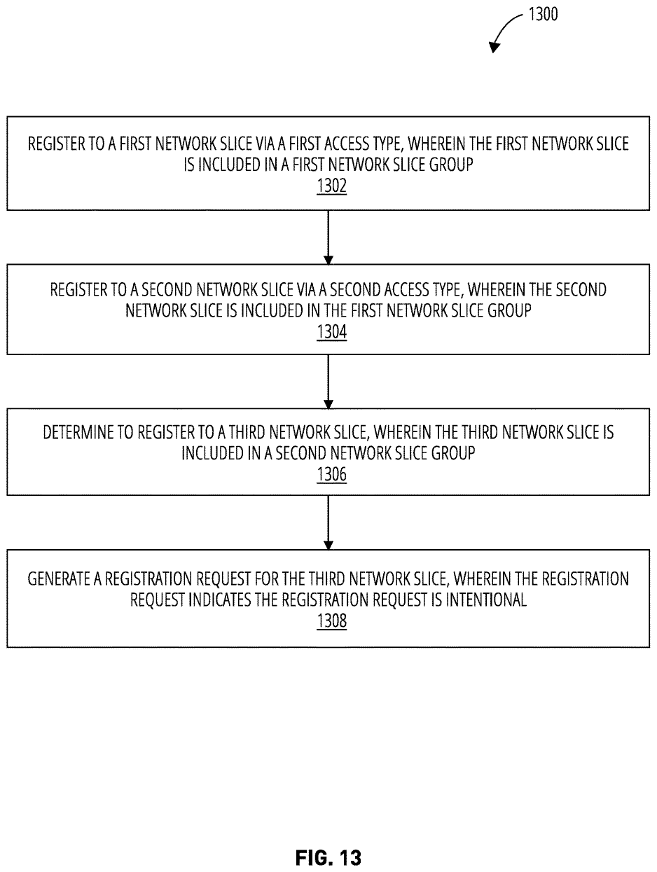

FIG. 13 illustrates a logic flow 1300 for supporting network slicing according to some embodiments. More specifically, the logic flow 1300 may relate to connecting to a network slice belonging to a different group when connected via both accesses to another group. This issue may arise in the following scenario: (1) UE has configured NSSAI and NSSRG mapping as follows: {S-NSSAI 1 (Group A), S-NSSAI 2 (Group A), S-NSSAI 3 (Group B), S-NSSAI 4 (Group B)}; (2) UE registers to S-NSSAI 1 via 3GPP access and S-NSSAI 2 via non-3GPP access (both Group A); and (3) at a later point UE wants to access services of Group B. However, if the UE sends a Registration request with Requested NSSAI indicating S-NSSAI 3 to 3GPP access, the AMF will reject it since on the other access the UE already has an allowed S-NSSAI with Group A.

To avoid this using existing techniques the UE redundantly (and therefore inefficiently) has to do an explicit deregistration on the other access and then try to connect to the preferred slice on the current access. This causes an unnecessary delay and additional signaling. Again when the service is done and if the UE wants to move back, the same sequence has to be repeated. This is because currently there is no way for an AMF to determine if the UE is requesting a slice belonging to a new group not matching with the other access erroneously or if it is an intentional request from the UE. If the UE can indicate that this is an intentional request and needs to override the group on the other access, then network can implicitly deregister the UE on the other access and also indicate the same in the Registration Accept using existing mechanisms.

To overcome this limitation, embodiments of the current disclosure may utilize one of the following solutions. A first solution introduces a new IE in the REGISTRATION REQUEST message that allows slice configurations to be overridden. In some embodiments, the new IE may include a parameter (e.g., a bit) for 3GPP access and a parameter (e.g., a bit) for non-3GPP access. If the parameter is set to 1 for 3GPP access then, when registering over non-3GPP access slice configuration over 3GPP access is overridden. If the parameter is set to 1 for non-3GPP access then, when registering over 3GPP access slice configuration over non-3GPP access is overridden. Accordingly, the IE may include a first portion for overriding the registration on a first type of access (e.g., 3GPP) and a second portion for overriding the registration on a second type of access (e.g., non-3GPP).

Another solution may include the following scenario. UE has allowed NSSAI on 3GPP as S-NSSAI1 and on non-3GPP as S-NSSAI2 and both belong to Group A. UE now wants to access services of S-NSSAI3 via 3GPP access, that belongs to Group B. Under the existing techniques, if the UE initiates Registration on S-NSSAI3 via 3GPP access, the UE is not allowed to initiate this and even if the UE attempts requesting S-NSSAI3, the network will not accept the same.

A number of techniques may be utilized to resolve this issue. In a first technique, a new IE explicitly indicating the group that the UE wants to request removal from may be utilized. The UE shall in Registration request include S-NSSAI3 in Requested NSSAI. Additionally, UE shall include a new IE indicating the NSSRG ID(s), whose associated S-NSSAI(s) the UE wants to be removed from the existing allowed NSSAI on both the accesses. When the network receives this IE, it shall remove from the allowed NSSAI all the S-NSSAI(s) having the associated with the included NSSRG ID. If there are no other S-NSSAI(s) associated with any other group currently in allowed NSSAI, the network shall consider the UE deregistered on both accesses and shall process the received Registration Request as an Initial Registration. Alternately the network might choose to process the received Registration Request as a Mobility registration and just consider the UE deregistered on the other access for the same case.

In a second technique, if the network receives a requested NSSAI with S-NSSAI(s) belonging to a group different from the group that is associated with the current allowed NSSAI and if within the requested NSSAI all the S-NSSAI(s) belong to the same NSSRG, then the network shall deem this to be an intentional request for change of group by the UE and not a use case of misconfiguration. The AMF shall process the new Requested NSSAI and shall consider the existing allowed NSSAI as no more part of the requested NSSAI and shall hence not deduce a conflict in NSSRG. Additionally, the AMF shall remove from allowed NSSAI on the other access all S-NSSAI(s) and shall consider the UE deregistered.

In a third technique, the UE shall for the scenario under consideration, first initiate a deregistration for non-3GPP access on 3GPP access or perform deregistration for both accesses simultaneously. Subsequently, the UE shall initiate Registration on 3GPP access with the new requested NSSAI. When the UE is registered on only one access, if the new requested NSSAI has S-NSSAI(s) belonging to the same group but is different from the NSSRG of the existing allowed NSSAI, the AMF shall not deduce an error, but shall rather consider this as a use case of UE wanting to access S-NSSAI(s) belonging to a different group. The AMF in this case, shall locally release the PDU sessions belonging to the S-NSSAIs present in the old Allowed NSSAI having a different NSSRG group from the ones UE is requesting in the requested NSSAI.

Referring back to FIG. 13, logic flow 1300 beings at block 1302. At block 1302 a first network slice may be registered via a first access type, wherein the first network slice is included in a first network slice group. For example, network slice A included in Group 1 may be registered via a 3GPP access type. Continuing to block 1304, a second network slice may be registered via a second access type, wherein the second network slice is included in the first network slice group. For example, network slice B included in Group 1 may be registered via a non-3GPP access type.

Proceeding to block 1306, it may be determined to register to a third network slice, wherein the third network slice is included in a second network slice group. For example, it may be determined to register for network slice C in Group 2. At block 1308 a registration request for the third network slice that indicates the registration request is intentional may be generated. For example, the value of an Override Slice Configuration IE may be set to 1 to indicate the registration request is intentional.

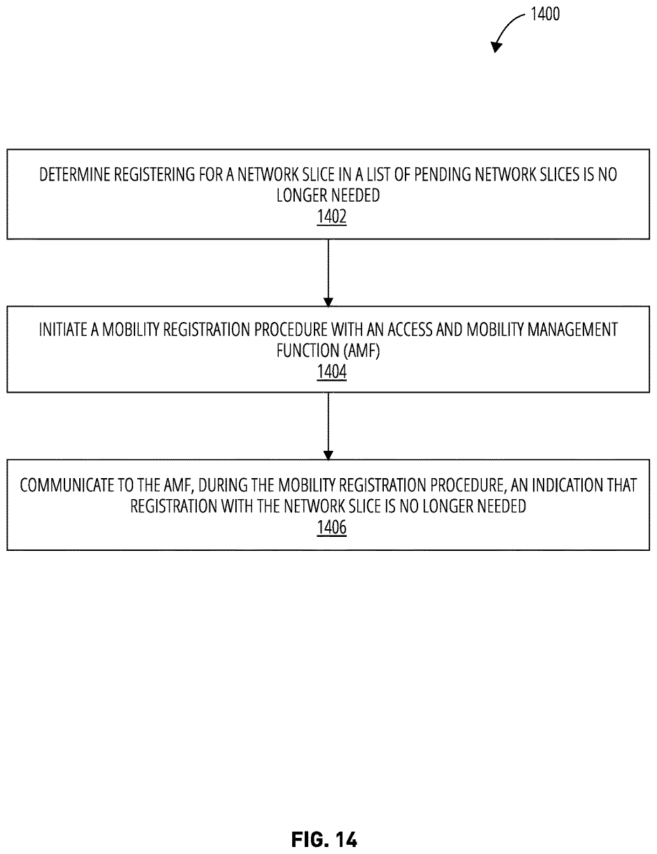

FIG. 14 illustrates a logic flow 1400 for supporting network slicing according to some embodiments. More specifically, the logic flow 1400 may relate to handling network slice group restrictions on pending network slices. This issue may arise in the following scenario: (1) during authentication (NSSAA) of slices, a specific slice (S-NSSAI) may be placed in a Pending NSSAI list if authentication is pending; (2) NSSRG restrictions apply to all S-NSSAIs that are included in the Requested NSSAI; and (3) the UE should consider the S-NSSAI in the Pending NSSAI as an S-NSSAI requested by the UE if the UE is still interested in the S-NSSAI of the Pending NSSAI and therefore the UE considers the S-NSSAIs in the Pending NSSAI which the UE is still interested in order to apply the NSSRG restrictions. However, for the case when the UE is no longer interested in a S-NSSAI in the Pending NSSAI, there is no mechanism to remove the S-NSSAI from the Pending NSSAI.

Thus, the network needs an explicit indication from the UE that the UE is no longer interested in a pending NSSAI if the UE wants to drop the pending NSSAI. A number of techniques may be utilized to resolve this issue.

In one technique, if the UE has stored the Pending NSSAI and the UE is no longer interested in S-NSSAI(s) of the pending NSSAI, the UE removes the S-NSSAI(s) in which it is no longer interested from the pending NSSAI list. The UE initiates a mobility registration procedure by sending a REGISTRATION REQUEST message containing the Discard NSSAI information element which is set to the S-NSSAI(s) of the pending NSSAI in which the UE is no longer interested. The S-NSSAIs in the pending NSSAI and requested NSSAI shall be associated with at least one common NSSRG value. If the AMF receives a discarded NSSAI in the REGISTRATION REQUEST message, the AMF removes the the S-NSSAI(s) present in the Discard NSSAI from the pending NSSAI list and aborts any ongoing NSSAA procedure(s) corresponding to the discard NSSAI

Alternately, in a second technique, if the UE has stored pending NSSAI and does not intend to register any S-NSSAI(s) of the pending NSSAI, the UE can apply NSSRG restriction (of Requested NSSAI) excluding the S-NSSAI(s) of the pending NSSAI. The AMF can assume UE wants to implicitly ignore S-NSSAI(s) included in pending NSSAI.

In a third technique, a override pending NSSAI IE may be introduced with a parameter (e.g., a bit) for 3GPP access and a parameter (e.g., a bit) for non-3GPP access. In this technique, the new IE indicates to the AMF which requested S-NSSAI(s) the UE wants to continue with. Any S-NSSAI that is not included in the Requested NSSAI is ignored and any ongoing NSSAA procedure is aborted by the network immediately. If this parameter is set to 1 for 3GPP access then, when registering over 3GPP access, slice configuration not included in the Requested NSSAI is ignored for 3GPP access and same for non-3GPP access. Race cases at both UE and network side is handled such that any received message relating to NSSAA procedure after the respective S-NSSAI(s) is no longer of interest to the UE then the NSSAA related message will be dropped by the receiving entity.

Referring back to FIG. 14, logic flow 1400 begins at block 1402. At block 1402 it may be determined that registering for a network slice in a list of pending network slices is no longer needed. For example, it may be determined that registering for network slice A is no longer needed, such as due to a change in circumstances no longer requires access to network slice A (e.g., no longer needs a multimedia connection due to application being closed).

Proceeding to block 1404, a mobility registration procedure with an Access and Mobility Management Function (AMF) may be initiated. For example, mobility registration procedure 1022 may be initiated. Continuing to block 1406, it may be communicated to the AMF, during the mobility registration procedure, an indication that registration with the network slice is no longer needed. For example, a bit may be set in an IE to indicate that registration with the network slice is not longer needed.

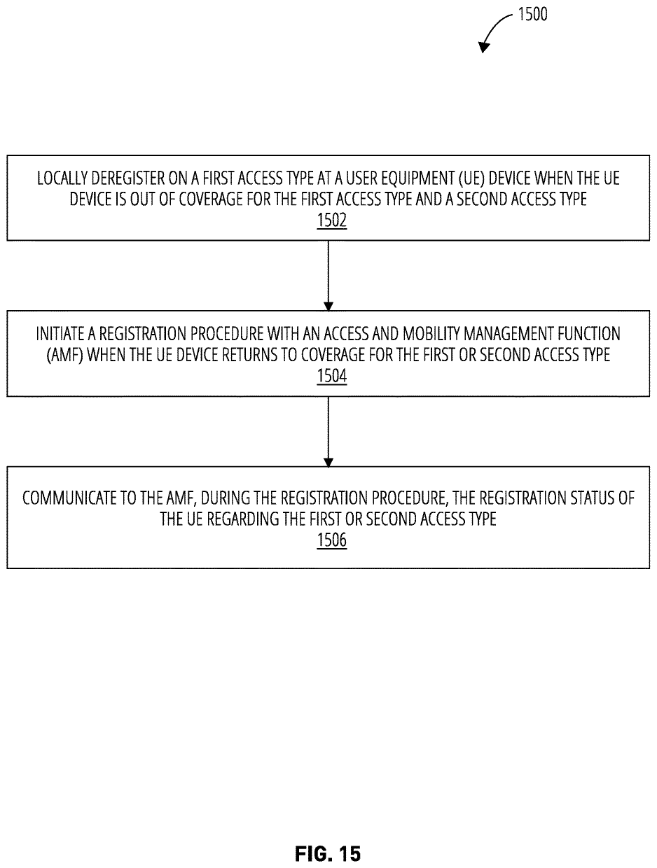

FIG. 15 illustrates a logic flow 1500 for supporting network slicing according to some embodiments. More specifically, the logic flow 1500 may relate to network rejections based on network slice groups being out of sync between the UE and the network. This issue may arise in the following scenario: the UE had to locally deregister on one of the accesses when being out of coverage on both the accesses on the same PLMN. The UE then returns back to coverage and initiates registration for a new group and receives registration accept indicating that the UE is registered on both accesses. In the context of NSSRG, this might lead to registration reject since the network thinks that the UE is wrongly requesting for a new group when already registered for another group via the other access. Accordingly, the UE must indicate to the network that it is no longer registered on the other access, such as using an IE. Embodiments are not limited in this context.

Logic flow 1500 begins at block 1502. At block 1502, a first access type may be locally deregistered from at a user equipment (UE) device when the UE device is out of coverage for the first access type and a second access type. Continuing to block 1504, a registration procedure with an Access and Mobility Management Function (AMF) may be initiated when the UE device returns to coverage for the first or second access type. Continuing to block 1506, during the registration procedure the registration status of the UE regarding the first or second access type may be communicated to the AMF, such as using an IE.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etcetera.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

There are a number of example embodiments described herein.

Example 1 is a computer-implemented method, comprising receiving an information element via a first mode of communication, the information element indicating a network slice is available for provision on a second mode of communication, wherein the information element includes a network slice identifier corresponding to the network slice; updating a list of configured network slices to include the network slice identifier; and registering to utilize the network slice on the second mode of communication based on the network slice identifier.

Example 2 is the computer-implemented method of Example 1 that may optionally include that registering to utilize the network slice on the second mode of communication based on the network slice identifier comprises providing a list of requested network slices including the network slice identifier to an Access and Mobility Management Function (AMF); and receiving a new list of configured network slices from the AMF, wherein the new list of configured network slices includes the network slice identifier and group information corresponding to a network slice group including the network slice.

Example 3 is the computer-implemented method of Example 2 that may optionally include that the new list of configured network slices is received via a UE Configuration Update procedure.

Example 4 is the computer-implemented method of Example 3 that may optionally include that the new list of configured network slices is received in a CONFIGURATION UPDATE COMMAND message during the UE Configuration Update procedure.

Example 5 is the computer-implemented method of Example 2 that may optionally include that the network slice group comprises a Network Slice Simultaneous Registration Group (NSSRG) and the group information includes values associated with the NSSRG.

Example 6 is the computer-implemented method of Example 5 that may optionally include that each network slice in the network slice group is simultaneously supported by the second mode of communication.

Example 7 is the computer-implemented method of Example 6 that may optionally include that each network slice in the list of configured network slices is included in the network slice group.

Example 8 is the computer-implemented method of Example 1 that may optionally include that the first mode of communication lacks support for 5G network slicing and the second mode of communication supports 5G network slicing.

Example 9 is the computer-implemented method of Example 1 that may optionally include that the first mode of communication utilizes evolved packet core (EPC) and the second mode of communication utilizes 5G core network.

Example 10 is the computer-implemented method of Example 1 that may optionally include that the list of configured network slices comprises a configured Network Slice Selection Assistance Information (NSSAI) and the network slice identifier is included in a Single-NSSAI (S-NSSAI) and the configured NSSAI includes one or more S-NSSAIs with associated slice group information.

Example 11 is the computer-implemented method of Example 10 that may optionally include that updating the list of configured network slices to include the network slice identifier includes updating the configured NSSAI to include the S-NSSAI, wherein the NSSAI is updated to include the S-NSSAI without associated slice group information.

Example 12 is the computer-implemented method of Example 1 that may optionally include that the information element includes the network slice identifier and group information corresponding to a network slice group including the network slice and the computer-implemented method further comprising updating the list of configured network slices to include the network slice identifier and the group information; and registering to utilize the network slice on the second mode of communication based on the network slice identifier and the group information.

Example 13 is the computer-implemented method of Example 12 that may optionally include that the network slice identifier and the network slice group are included in an extended protocol configuration options (ePCO) portion of the information element.

Example 14 is the computer-implemented method of Example 12 that may optionally include that the list of configured network slices comprises a configured Network Slice Selection Assistance Information (NSSAI), the network slice identifier is included in a Single-NSSAI (S-NSSAI), the network slice group comprises a Network Slice Simultaneous Registration Group (NSSRG), and the group information includes values associated with the NSSRG.

Example 15 is the computer-implemented method of Example 1 that may optionally include that updating the list of configured network slices to include the network slice identifier and the group information includes updating the configured NSSAI to include the S-NSSAI and the values associated with the NSSRG.

Example 16 is the computer-implemented method of Example 1 that may optionally include that the information element is received during a packet data network (PDN) connection establishment procedure.

Example 17 is a user equipment (UE) comprising one or more processors configured to perform the computer-implemented method of any of Examples 1 to 16.

Example 18 is a non-transitory machine-readable medium having executable instructions to cause one or more processing units to perform the computer-implemented method of any of Examples 1 to 16.

Example 19 is a computer implemented method comprising transmitting an information element to a user equipment (UE) via a first mode of communication, the information element indicating a network slice is available for provision on a second mode of communication, wherein the information element includes a network slice identifier corresponding to the network slice, wherein the information element causes the UE to update a list of configured network slices to include the network slice identifier; receiving the list of configured network slices including the network slice identifier from the UE; and utilizing the list of configured network slices including the network slice identifier to register the UE to utilize the network slice on the second mode of communication.

Example 20 is the computer-implemented method of Example 19 that may optionally include that utilizing the list of configured network slices including the network slice identifier to register the UE to utilize the network slice on the second mode of communication comprises relaying, a list of requested network slices including the network slice identifier received from the UE to an Access and Mobility Management Function (AMF); receiving a new list of configured network slices from the AMF, wherein the new list of configured network slices includes the network slice identifier and group information corresponding to a network slice group including the network slice; and transmitting the new list of configured network slices to the UE.

Example 21 is the computer-implemented method of Example 20 that may optionally include that the new list of configured network slices is received via a UE Configuration Update procedure.

Example 22 is the computer-implemented method of Example 21 that may optionally include that the new list of configured network slices is received in a CONFIGURATION UPDATE COMMAND message during the UE Configuration Update procedure.

Example 23 is the computer-implemented method of Example 20 that may optionally include that the network slice group comprises a Network Slice Simultaneous Registration Group (NSSRG) and the group information includes values associated with the NSSRG.

Example 24 is the computer-implemented method of Example 23 that may optionally include that each network slice in the network slice group is simultaneously supported by the second mode of communication.

Example 25 is the computer-implemented method of Example 24 that may optionally include that each network slice in the list of configured network slices is included in the network slice group.

Example 26 is the computer-implemented method of Example 19 that may optionally include that the first mode of communication lacks support for 5G network slicing and the second mode of communication supports 5G network slicing.

Example 27 is the computer-implemented method of Example 19 that may optionally include that the first mode of communication utilizes evolved packet core (EPC) and the second mode of communication utilizes 5G core network.

Example 28 is the computer-implemented method of Example 19 that may optionally include that the list of configured network slices comprises a configured Network Slice Selection Assistance Information (NSSAI) and the network slice identifier is included in a Single-NSSAI (S-NSSAI) and the configured NSSAI includes one or more S-NSSAIs with associated slice group information.

Example 29 is the computer-implemented method of Example 28 that may optionally include that causing the UE to update the list of configured network slices to include the network slice identifier includes causing the UE to update the configured NSSAI to include the S-NSSAI without associated slice group information.

Example 30 is the computer-implemented method of Example 19 that may optionally include that the information element includes the network slice identifier and group information corresponding to a network slice group including the network slice and the one or more processors are further configured to perform operations comprising causing the UE to update the list of configured network slices to include the network slice identifier and the group information; and utilizing the list of configured network slices including the network slice identifier and the group information to register the UE to utilize the network slice on the second mode of communication.

Example 31 is the computer-implemented method of Example 30 that may optionally include that the network slice identifier and the network slice group are included in an extended protocol configuration options (ePCO) portion of the information element.

Example 32 is the computer-implemented method of Example 30 that may optionally include that the list of configured network slices comprises a configured Network Slice Selection Assistance Information (NSSAI), the network slice identifier is included in a Single-NSSAI (S-NSSAI), the network slice group comprises a Network Slice Simultaneous Registration Group (NSSRG), and the group information includes values associated with the NSSRG.

Example 33 is the computer-implemented method of Example 32 that may optionally include that causing the UE to update the list of configured network slices to include the network slice identifier and the group information includes updating the configured NSSAI to include the S-NSSAI and the values associated with the NSSRG.

Example 34 is the computer-implemented method of Example 19 that may optionally include that the information element is transmitted to the UE during a packet data network (PDN) connection establishment procedure.

Example 35 is a base station (BS) comprising one or more processors configured to perform the computer-implemented method of any of Examples 19 to 34.

Example 36 is a non-transitory machine-readable medium having executable instructions to cause one or more processing units to perform the computer-implemented method of any of Examples 19 to 34.

Example 37 is a computer-implemented method comprising: receiving an information element via a first mode of communication at a user equipment (UE) device, the information element indicating a network slice is available for provision on a second mode of communication, wherein the information element includes a network slice identifier corresponding to the network slice and group information corresponding to a network slice group including the network slice; updating a list of configured network slices to include the network slice identifier and the group information; and registering to utilize the network slice on the second mode of communication based on the network slice identifier and the group information.

Example 38 is the computer-implemented method of Example 37 that may optionally include that each network slice in the network slice group is simultaneously supported by the second mode of communication.

Example 39 is the computer-implemented method of Example 38 that may optionally include that each network slice in the list of configured network slices is included in the network slice group.

Example 40 is the computer-implemented method of Example 37 that may optionally include that the first mode of communication lacks support for 5G network slicing and the second mode of communication supports 5G network slicing.

Example 41 is the computer-implemented method of Example 37 that may optionally include that the first mode of communication utilizes evolved packet core and the second mode of communication utilizes 5G core network.

Example 42 is the computer-implemented method of Example 37 that may optionally include that the list of configured network slices comprises a configured Network Slice Selection Assistance Information (NSSAI) and the network slice identifier is included in a Single-NSSAI (S-NSSAI).

Example 43 is the computer-implemented method of Example 42 that may optionally include that updating the list of configured network slices to include the network slice identifier and the group information includes updating the configured NSSAI to include the S-NSSAI

Example 44 is the computer-implemented method of Example 42 that may optionally include that the network slice group comprises a Network Slice Simultaneous Registration Group (NSSRG) and the group information includes values associated with the NSSRG.

Example 45 is the computer-implemented method of Example 44 that may optionally include that updating the list of configured network slices to include the network slice identifier and the group information includes updating the configured NSSAI to include the S-NSSAI and the values associated with the NSSRG.

Example 46 is the computer-implemented method of Example 37 that may optionally include that the information element is received during a packet data network (PDN) connection establishment procedure.

Example 47 is the computer-implemented method of Example 37 that may optionally include that the network slice identifier and the network slice group are included in an extended protocol configuration options (ePCO) portion of the information element.

Example 48 is a user equipment (UE) comprising one or more processors configured to perform the computer-implemented method of any of Examples 37 to 47.

Example 49 is a non-transitory machine-readable medium having executable instructions to cause one or more processing units to perform the computer-implemented method of any of claims 37 to 47.

Example 50 is a computer-implemented method comprising: transmitting an information element to a user equipment (UE) via a first mode of communication at a user equipment (UE) device, the information element indicating a network slice is available for provision on a second mode of communication, wherein the information element includes a network slice identifier corresponding to the network slice and group information corresponding to a network slice group including the network slice and the information element causes the UE to update a list of configured network slices to include the network slice identifier and the group information; receiving the list of configured network slices including the network slice identifier from the UE; and utilizing the list of configured network slices including the network slice identifier and the group information to register the UE to utilize the network slice on the second mode of communication.

Example 51 is the computer-implemented method of Example 50 that may optionally include that each network slice in the network slice group is simultaneously supported by the second mode of communication.

Example 52 is the computer-implemented method of Example 51 that may optionally include that each network slice in the list of configured network slices is included in the network slice group.

Example 53 is the computer-implemented method of Example 50 that may optionally include that the first mode of communication lacks support for 5G network slicing and the second mode of communication supports 5G network slicing.

Example 54 is the computer-implemented method of Example 50 that may optionally include that the first mode of communication utilizes evolved packet core and the second mode of communication utilizes 5G core network.

Example 55 is the computer-implemented method of Example 50 that may optionally include that the list of configured network slices comprises a configured Network Slice Selection Assistance Information (NSSAI) and the network slice identifier is included in a Single-NSSAI (S-NSSAI).

Example 56 is the computer-implemented method of Example 55 that may optionally include that causing the UE to update the list of configured network slices to include the network slice identifier and the group information includes updating the configured NSSAI to include the S-NSSAI.

Example 57 is the computer-implemented method of Example 55 that may optionally include that the network slice group comprises a Network Slice Simultaneous Registration Group (NSSRG) and the group information includes values associated with the NSSRG.

Example 58 is the computer-implemented method of Example 57 that may optionally include that causing the UE to update the list of configured network slices to include the network slice identifier and the group information includes updating the configured NSSAI to include the S-NSSAI and the values associated with the NSSRG.

Example 59 is the computer-implemented method of Example 50 that may optionally include that the information element is received during a packet data network (PDN) connection establishment procedure.

Example 60 is the computer-implemented method of Example 50 that may optionally include that the network slice identifier and the network slice group are included in an extended protocol configuration options (ePCO) portion of the information element.

Example 61 is a base station (BS) comprising one or more processors configured to perform the computer-implemented method of any of Examples 50 to 60.

Example 62 is a non-transitory machine-readable medium having executable instructions to cause one or more processing units to perform the computer-implemented method of any of Examples 50 to 60.

Example 63 is a computer-implemented method comprising receiving, at a user equipment (UE) device, a new list of configured network slices during a UE Configuration Update procedure; failing to receive an information element (IE) with new group information associated with the list of configured network slices during the UE Configuration Update procedure; and deleting old group information in response to receiving the new list of configured network slices and failing to receive the new group information associated with the list of configured network slices during the UE Configuration Update procedure.

Example 64 is the computer-implemented method of Example 63 that may optionally include that the new list of configured network slices is received in a CONFIGURATION UPDATE COMMAND message.

Example 65 is the computer-implemented method of Example 63 that may optionally include that the new list of configured network slices is received in a REGISTRATION ACCEPT message.

Example 66 is the computer-implemented method of Example 63 that may optionally include that failing to receive new group information associated with the list of configured network slices during the UE Configuration Update procedure comprises failing to receive a Network Slice Simultaneous Registration Group (NSSRG) information IE.

Example 67 is the computer-implemented method of Example 63 that may optionally include that deleting old group information comprises deleting Network Slice Simultaneous Registration Group (NSSRG) information stored on the UE.

Example 68 is a user equipment (UE) comprising one or more processors configured to perform the computer-implemented method of any of Examples 63 to 67.

Example 69 is a non-transitory machine-readable medium having executable instructions to cause one or more processing units to perform the computer-implemented method of any of Examples 63 to 67.

Example 70 is a computer-implemented method comprising transmitting a new list of configured network slices during a UE Configuration Update procedure to a user equipment (UE); failing to transmit an information element (IE) with new group information associated with the list of configured network slices during the UE Configuration Update procedure to the UE; and causing the UE to delete old group information in response to transmitting the new list of configured network slices to the UE and failing to transmit the new group information associated with the list of configured network slices during the UE Configuration Update procedure to the UE.

Example 71 is the computer-implemented method of Example 70 that may optionally include that the new list of configured network slices is transmitted in a CONFIGURATION UPDATE COMMAND message.

Example 72 is the computer-implemented method of Example 70 that may optionally include that the new list of configured network slices is transmitted in a REGISTRATION ACCEPT message.

Example 73 is the computer-implemented method of Example 70 that may optionally include that failing to transmit new group information associated with the list of configured network slices during the UE Configuration Update procedure to the UE comprises failing to transmit a Network Slice Simultaneous Registration Group (NSSRG) information IE to the UE.

Example 74 is the computer-implemented method of Example 70 that may optionally include that causing the UE to delete old group information comprises causing the UE to delete Network Slice Simultaneous Registration Group (NSSRG) information stored on the UE.

Example 75 is a base station (BS) comprising one or more processors configured to perform the computer-implemented method of any of Examples 70 to 74

Example 76 is a non-transitory machine-readable medium having executable instructions to cause one or more processing units to perform the computer-implemented method of any of Examples 70 to 74.

Example 77 is a computer-implemented method comprising: registering to a first network slice via a first access type, wherein the first network slice is included in a first network slice group; registering to a second network slice via a second access type, wherein the second network slice is included in the first network slice group; determining to register to a third network slice, wherein the third network slice is included in a second network slice group; and generating a registration request for the third network slice, wherein the registration request indicates the registration request is intentional.

Example 78 is the computer-implemented method of Example 77 that may optionally include that the first access type comprises 3GPP access and the second access type comprises non-3GPP access.

Example 79 is the computer-implemented method of Example 77 that may optionally include that the registration request indicates the registration request is intentional via an override slice configuration information element (IE).

Example 80 is the computer-implemented method of Example 79 that may optionally include that the override slice configuration IE includes a portion for overriding registration on the first type of access and a portion for overriding registration on the second type of access.

Example 81 is the computer-implemented method of Example 79 that may optionally include that the registration request for the third network slice is for the first access type and the override slice configuration IE indicates access slice configuration over the second type of access is overridden for network slice groups other than the second network slice group including the third network slice.

Example 82 is the computer-implemented method of Example 79 that may optionally include that the registration request for the third network slice is for the second access type and the override slice configuration IE indicates access slice configuration over the first type of access is overridden for network slice groups other than the second network slice group including the third network slice.

Example 83 is a user equipment (UE) comprising one or more processors configured to perform the computer-implemented method of any of Examples 77 to 82.

Example 84 is a non-transitory machine-readable medium having executable instructions to cause one or more processing units to perform the computer-implemented method of any of Examples 77 to 82.

Example 85 is a computer-implemented method comprising one or more processors configured to perform operations comprising: registering a user equipment (UE) to a first network slice via a first access type, wherein the first network slice is included in a first network slice group; registering the UE to a second network slice via a second access type, wherein the second network slice is included in the first network slice group; and in response to the UE determining to register to a third network slice included in a second network slice group, receiving a registration request from the UE for the third network slice, wherein the registration request indicates the registration request is intentional.

Example 86 is the computer-implemented method of Example 85 that may optionally include that the first access type comprises 3GPP access and the second access type comprises non-3GPP access.

Example 87 is the computer-implemented method of Example 85 that may optionally include that the registration request indicates the registration request is intentional via an override slice configuration information element (IE).

Example 88 is the computer-implemented method of Example 87 that may optionally include that the override slice configuration IE includes a portion for overriding registration on the first type of access and a portion for overriding registration on the second type of access.

Example 89 is the computer-implemented method of Example 87 that may optionally include that the registration request for the third network slice is for the first access type and the override slice configuration IE indicates access slice configuration over the second type of access is overridden for network slice groups other than the second network slice group including the third network slice.

Example 90 is the computer-implemented method of Example 87 that may optionally include that the registration request for the third network slice is for the second access type and the override slice configuration IE indicates access slice configuration over the first type of access is overridden for network slice groups other than the second network slice group including the third network slice.

Example 91 is a base station (BS) comprising one or more processors configured to perform the computer-implemented method of any of Examples 85 to 90.

Example 92 is a non-transitory machine-readable medium having executable instructions to cause one or more processing units to perform the computer-implemented method of any of Examples 85 to 90.

Example 93 is a computer-implemented method comprising: determining registering for a network slice in a list of pending network slices is no longer needed; initiating a mobility registration procedure with an Access and Mobility Management Function (AMF); and communicating to the AMF, during the mobility registration procedure, an indication that registration with the network slice is no longer needed.

Example 94 is the computer-implemented method of Example 93 that may optionally include that the indication that registration with the network slice is no longer needed is included in a REGISTRATION REQUEST message.

Example 95 is the computer-implemented method of Example 94 that may optionally include that the indication that registration with the network slice is no longer needed is included in a discard information element (IE).

Example 96 is the computer-implemented method of Example 95 that may optionally include that the list of pending network slices comprises a pending Network Slice Selection Information (NSSAI) and the network slice corresponds to a single-NSSAI (S-NSSAI) in the pending NSSAI.

Example 97 is the computer-implemented method of Example 69 that may optionally include that the discard IE comprises a Discard NSSAI IE.

Example 98 is a user equipment (UE) comprising one or more processors configured to perform the computer-implemented method of any of Examples 93 to 97.

Example 99 is a non-transitory machine-readable medium having executable instructions to cause one or more processing units to perform the computer-implemented method of any of Examples 93 to 97.

Example 100 is a computer-implemented method comprising: in response to a user equipment (UE) determining registering for a network slice in a list of pending network slices is no longer needed, relaying an initiation of a mobility registration procedure from the UE to an Access and Mobility Management Function (AMF); and relaying from the UE to the AMF, during the mobility registration procedure, an indication that registration with the network slice is no longer needed to cause the AMF to remove the network slice from the list of pending network slices.

Example 101 is the computer-implemented method of Example 100 that may optionally include that the indication that registration with the network slice is no longer needed is included in a REGISTRATION REQUEST message.

Example 102 is the computer-implemented method of Example 101 that may optionally include that the indication that registration with the network slice is no longer needed is included in a discard information element (IE).

Example 103 is the computer-implemented method of Example 102 that may optionally include that the list of pending network slices comprises a pending Network Slice Selection Information (NSSAI) and the network slice corresponds to a single-NSSAI (S-NSSAI) in the pending NSSAI.

Example 104 is the computer-implemented method of Example 103 that may optionally include that the discard IE comprises a Discard NSSAI IE.

Example 105 is a base station (BS) comprising one or more processors configured to perform the computer-implemented method of any of Examples 100 to 104.

Example 106 is a non-transitory machine-readable medium having executable instructions to cause one or more processing units to perform the computer-implemented method of any of Examples 100 to 104.

Example 107 is a computer-implemented method comprising locally deregistering on a first access type at a user equipment (UE) when the UE is out of coverage for the first access type and a second access type; initiating a registration procedure with an Access and Mobility Management Function (AMF) when the UE returns to coverage for the first or second access type; and communicating to the AMF, during the registration procedure, the registration status of the UE regarding the first or second access type.

Example 108 is the computer-implemented method of Example 107 that may optionally include that communication of the registration status of the UE regarding the first or second access type includes indicating the UE is deregistered from the first access type.

Example 109 is the computer-implemented method of Example 107 that may optionally include that communication of the registration status of the UE regarding the first or second access type includes indicating the UE is only registered to the second access type.

Example 110 is a user equipment (UE) comprising one or more processors configured to perform the computer-implemented method of any of Examples 107 to 109.

Example 111 is a non-transitory machine-readable medium having executable instructions to cause one or more processing units to perform the computer-implemented method of any of Examples 107 to 109.

Example 112 is a computer-implemented method comprising in response to a user equipment (UE) locally deregistering on a first access type when the UE is out of coverage for the first access type and a second access type, relaying an initiation of a registration procedure from the UE to an Access and Mobility Management Function (AMF) when the UE returns to coverage for the first or second access type; and relaying from the UE to the AMF, during the registration procedure, the registration status of the UE regarding the first or second access type.

Example 113 is the computer-implemented method of Example 112 that may optionally include that relaying the registration status of the UE regarding the first or second access type includes indicating the UE is deregistered from the first access type.

Example 114 is the computer-implemented method of Example 112 that may optionally include that relaying the registration status of the UE regarding the first or second access type includes indicating the UE is only registered to the second access type.

Example 115 is a base station (BS) comprising one or more processors configured to perform the computer-implemented method of any of Examples 112 to 114.

Example 116 is a non-transitory machine-readable medium having executable instructions to cause one or more processing units to perform the computer-implemented method of any of Examples 112 to 114.

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing discussion merely describes some exemplary embodiments of the present invention. One skilled in the art will readily recognize from such discussion, the accompanying drawings and the claims that various modifications can be made without departing from the spirit and scope of the invention.

1. A user equipment (UE) comprising one or more processors configured to perform operations comprising:
receiving an information element via a first mode of communication, the information element indicating a network slice is available for provision on a second mode of communication, wherein the information element includes a network slice identifier corresponding to the network slice;
updating a list of configured network slices to include the network slice identifier; and
registering to utilize the network slice on the second mode of communication based on the network slice identifier.

2. The UE of claim 1, wherein registering to utilize the network slice on the second mode of communication based on the network slice identifier comprises:
providing a list of requested network slices including the network slice identifier to an Access and Mobility Management Function (AMF); and
receiving a new list of configured network slices from the AMF, wherein the new list of configured network slices includes the network slice identifier and group information corresponding to a network slice group including the network slice.

3. The UE of claim 2, wherein the new list of configured network slices is received via a UE Configuration Update procedure.

4. The UE of claim 3, wherein the new list of configured network slices is received in a CONFIGURATION UPDATE COMMAND message during the UE Configuration Update procedure.

5. The UE of claim 2, wherein the network slice group comprises a Network Slice Simultaneous Registration Group (NSSRG) and the group information includes values associated with the NSSRG.

6. The UE of claim 5, wherein each network slice in the network slice group is simultaneously supported by the second mode of communication.

7. The UE of claim 6, wherein each network slice in the list of configured network slices is included in the network slice group.

8-16. (canceled)

17. A computer-implemented method, comprising:
receiving an information element via a first mode of communication, the information element indicating a network slice is available for provision on a second mode of communication, wherein the information element includes a network slice identifier corresponding to the network slice;
updating a list of configured network slices to include the network slice identifier; and
registering to utilize the network slice on the second mode of communication based on the network slice identifier.

18. The computer-implemented method of claim 17, wherein registering to utilize the network slice on the second mode of communication based on the network slice identifier comprises:
providing a list of requested network slices including the network slice identifier to an Access and Mobility Management Function (AMF); and
receiving a new list of configured network slices from the AMF, wherein the new list of configured network slices includes the network slice identifier and group information corresponding to a network slice group including the network slice.

19-23. (canceled)

24. The computer-implemented method of claim 17, wherein the first mode of communication lacks support for 5G network slicing and the second mode of communication supports 5G network slicing.

25. The computer-implemented method of claim 17, wherein the first mode of communication utilizes evolved packet core (EPC) and the second mode of communication utilizes 5G core network.

26. The computer-implemented method of claim 17, wherein the list of configured network slices comprises a configured Network Slice Selection Assistance Information (NSSAI) and the network slice identifier is included in a Single-NSSAI (S-NSSAI) and the configured NSSAI includes one or more S-NSSAIs with associated slice group information.

27. The computer-implemented method of claim 26, wherein updating the list of configured network slices to include the network slice identifier includes updating the configured NSSAI to include the S-NSSAI, wherein the NSSAI is updated to include the S-NSSAI without associated slice group information.

28-32. (canceled)

33. A non-transitory machine-readable medium having executable instructions to cause one or more processing units to perform a method, the method comprising:
receiving an information element via a first mode of communication, the information element indicating a network slice is available for provision on a second mode of communication, wherein the information element includes a network slice identifier corresponding to the network slice;
updating a list of configured network slices to include the network slice identifier; and
registering to utilize the network slice on the second mode of communication based on the network slice identifier.

34. The non-transitory machine-readable medium of claim 33, wherein registering to utilize the network slice on the second mode of communication based on the network slice identifier comprises:
providing a list of requested network slices including the network slice identifier to an Access and Mobility Management Function (AMF); and
receiving a new list of configured network slices from the AMF, wherein the new list of configured network slices includes the network slice identifier and group information corresponding to a network slice group including the network slice.

35-43. (canceled)

44. The non-transitory machine-readable medium of claim 33, wherein the information element includes the network slice identifier and group information corresponding to a network slice group including the network slice and the non-transitory machine-readable medium having instructions to cause one or more processing units to perform the method further comprising:
updating the list of configured network slices to include the network slice identifier and the group information; and
registering to utilize the network slice on the second mode of communication based on the network slice identifier and the group information.

45. The non-transitory machine-readable medium of claim 44, wherein the network slice identifier and the network slice group are included in an extended protocol configuration options (ePCO) portion of the information element.

46. The non-transitory machine-readable medium of claim 44, wherein the list of configured network slices comprises a configured Network Slice Selection Assistance Information (NSSAI), the network slice identifier is included in a Single-NSSAI (S-NSSAI), the network slice group comprises a Network Slice Simultaneous Registration Group (NSSRG), and the group information includes values associated with the NSSRG.

47. The non-transitory machine-readable medium of claim 46, wherein updating the list of configured network slices to include the network slice identifier and the group information includes updating the configured NSSAI to include the S-NSSAI and the values associated with the NSSRG.

48. The non-transitory machine-readable medium of claim 33, wherein the information element is received during a packet data network (PDN) connection establishment procedure.

49-176. (canceled)
